(19) United States
(12) Patent Application Publication
(10) Pub. No.: US 2003/0200081 A1
(43) Pub. Date: Oct. 23, 2003

(54) Audio signal decoding and encoding device, decoding device and encoding device

(76) Inventors: Tetsuro Wada, Tokyo (JP); Atsushi Hotta, Tokyo (JP)

Correspondence Address: BIRCH STEWART KOLASCH & BIRCH, PO BOX 747, FALLS CHURCH, VA, 22040-0747, US

(21) Appl. No.: 10/418,176

(22) Filed: Apr. 18, 2003

(30) Foreign Application Priority Data
Apr. 22, 2002 (JP) 2002-119215

(51) Int. Cl. G10L 19/00

(52) U.S. Cl. 704/200.1

(57) ABSTRACT

An audio signal decoding and encoding device has a decoding device having a stream separating circuit, a control signal decoding circuit for outputting blocking information, a decoding and dequantizing circuit, a frequency-time converting circuit, and an information multiplexing circuit for multiplexing a time domain signal and the blocking information and an encoding device having an information separating circuit for separating the time domain signal and the blocking information from a multiplex signal, a time-frequency converting circuit, a psycho-acoustic model circuit, a control signal encoding circuit, a quantizing and encoding circuit, a stream multiplexing circuit, and an output control circuit for controlling output timing of an encoded stream on the basis of the blocking information so that the processing delay time within the device becomes fixed.

### BACKGROUND OF THE INVENTION

1. Field of the Invention

The present invention relates in general to an audio signal decoding and encoding device for compressing an audio signal with high efficiency to transmit the resultant signal, a decoding device and an encoding device.

2. Description of the Related Art

For the transmission of an audio signal, in order to efficiently utilize a transmission line, an encoding device and a decoding device are used. As for an encoding method and a decoding method adopted in those devices, various methods have been proposed.

For example, first of all, an audio signal of a time domain is blocked every unit time and then is converted into short-time spectrum components every signal block. Thereafter, the quantization and the encoding are carried out according to the decided bit assignment using a psycho-acoustic model on the basis of the short-time spectrum components. The bit stream generated by the encoding is decoded in accordance with the reverse procedure to reproduce the audio signal of a time domain.

The above-mentioned psycho-acoustic model means the model of the signal analysis utilizing the acoustic sense property of a human being. For example, the degree of the masking effect is calculated as an index called a masking threshold. The masking effect means the phenomenon in which when a certain sound signal is present, a small sound signal having a frequency around the frequency of the certain sound signal can not be heard. The audio signal is analyzed every time block by utilizing this property when the audio signal is encoded, and only the signals which a human being can feel with his/her acoustic sense are encoded to be transmitted.

By the way, the encoding device and the decoding device are connected in a cascade style in accordance with the purpose of the application thereof in some cases. In the well known encoding and decoding device, the tone quality of the reproduced audio signal is further degraded as the encoding and the decoding are repeated many times for the audio signal. Then, there is proposed the method in which the characteristic information in the encoding in addition to the time block information is transmitted to the subsequent stages (Japanese Patent Laid-Open No. 9-503637 and Japanese Patent Laid-Open No. 2001-134293).

Conventional audio signal decoding and encoding device will now be described with reference to FIGS. 9 and 10. FIG. 9 is a block diagram showing a configuration of the conventional audio signal decoding and encoding device shown in Japanese Patent Laid-Open No. 2001-134293, for instance.

In FIG. 9, reference numeral 71 denotes a decoding device; reference numeral 72 denotes an encoding device; and reference numeral 73 denotes a signal processor. In addition, reference numeral 74 denotes a stream separating circuit; reference numeral 75 denotes a control signal decoding circuit; reference numeral 76 denotes a decoding and dequantizing circuit; reference numeral 77 denotes a frequency-time converting circuit; and reference numeral 78 denotes a psycho-acoustic model reconstituting circuit. Moreover, reference numeral 79 denotes a time-frequency converting circuit; reference numeral 80 denotes a psycho-acoustic model converting circuit; reference numeral 81 denotes a control signal encoding circuit; reference numeral 82 denotes a quantizing and encoding circuit; and reference numeral 83 denotes a stream multiplexing circuit.

Next, the operation of the conventional audio signal decoding and encoding device will hereinbelow be described with reference to FIGS. 9 and 10.

The form of the cascade connection is such that the decoding device and the encoding device each shown in FIG. 9 are continuously connected. The decoding and encoding device shown in FIG. 9 is constituted by the decoding device 71, the encoding device 72 and the signal processor 73.

In the decoding device 71, the bit stream inputted thereto is separated into a control signal and a main signal by the stream separating circuit 74, and the control signal is decoded by the control signal decoding circuit 75.

In the decoding and dequantizing circuit 76, the main signal is decoded and dequantized in accordance with the control information. The resultant output signal is frequency-time converted by the frequency-time converting circuit 77 to obtain a time domain signal. In addition, the above-mentioned control signal is inputted to the psycho-acoustic model reconstituting circuit 78 which reconstitutes in turn the psycho-acoustic model in accordance with the control information.

The decoding device 71 outputs a time signal to the signal processor 73 and also outputs the blocking information and parameters of the psycho-acoustic model to the encoding device 72.

In the signal processor 73, the equalizer processing, the mixing processing and the like are executed for the reproduced audio signal as the time domain signal outputted from the decoding device 71. Of course, the reproduced audio signal maybe directly outputted to the encoding device 72 without executing any of the processings in some cases. This is regarded as non-interposition of the signal processor 73.

By the way, as for the interface through which the decoding device 71 and the signal processor 73, or the signal processor 73 or the decoding device 71 and the encoding device 72 are connected, the digital audio interface conforming to the AES3 (Audio Engineering Society 3) Standard or the IEC (International Electrotechnical Commission) 60958 Standard is used in many cases.

In the encoding device 72, first of all, the time domain signal inputted thereto is converted on the basis of the blocking information from the decoding device 71 by the time-frequency converting circuit 79. In tandem therewith, the psycho-acoustic model converting circuit 80 constitutes, while taking into account the signal processing information from the signal processor 73, on the basis of the parameters of the psycho-acoustic model from the decoding device 71, the psycho-acoustic model for the time domain signal.

The control signal encoding circuit 81 generates a control signal for the quantization and the encoding on the basis of the psycho-acoustic model. After having requantized and encoded the time domain signal in accordance with the control signal, the quantizing and encoding circuit 82 outputs the resultant signal to the stream multiplexing circuit 83. The control signal is also encoded by the control signal encoding circuit 81 to be outputted to the stream multiplexing circuit 83 which multiplexes in turn all of these signals to output the resultant multiplex signal.

By the way, regarding the encoding device 72, in the time-frequency converting circuit 79, there is adjusted the timing at which the processing for the time domain signal inputted on the basis of the blocking information, and the encoding in the encoding device 72 is to be executed.

That is to say, as shown in FIG. 10, the encoding processing is started at the first frame timing after all the data of the data block has been inputted. Thus, a period of time from input of the audio signal to the device to output of the audio signal therefrom, i.e., the delay time is changed in accordance with the timing at which the block of the input data is inputted and the frame timing of the encoding device.

In such a decoding and encoding device, since in the repetition of a series of encoding processings, the characteristic information for the encoding such as blocking information in the prior stage that is cascade-connected is transmitted to the next stage, and the reencoding is carried out on the basis of that information, the quantity degradation can be suppressed.

In the conventional audio signal decoding and encoding device as described above, there is encountered a problem in that when the encoded information is transmitted to the next stage that is cascade-connected, an interface for information transmission is newly required, and hence the circuit scale is increased.

In addition, since it is necessary to previously grasp the contents with respect to what processing is executed in the signal processor, there is encountered a problem in that the restriction occurs in the combination of the devices that are cascade-connected.

Furthermore, since the delay time when the audio signal passes through the devices is changed every device or every activation of the device, there is encountered a problem in that the conventional audio signal decoding and encoding device is difficult to be applied to the transmission line for which it is necessary to fix the delay time to fixed time.

### SUMMARY OF THE INVENTION

In the light of the foregoing, the present invention has been made in order to solve the above-mentioned problems associated with the prior art, and it is, therefore, an object of the present invention to provide a decoding and encoding device for which a new interface for transmission of encoded information is unnecessary, in particular, an audio signal decoding and encoding device which is capable of transmitting synchronously blocking information, and which is capable of fixing the delay time when an audio signal passes through all the devices connected in a cascade style, a decoding device and an encoding device.

In order to attain the above-mentioned object, according to an aspect of the present invention, there is provided an audio signal decoding and encoding device including a decoding device and an encoding device.

The decoding device has a stream separating circuit for separating a main signal and a control signal from an encoded stream, a control signal decoding circuit for decoding the control signal obtained through the separation process to output blocking information, a decoding and dequantizing circuit for decoding and dequantizing the main signal obtained through the separation process in accordance with the decoded control signal, a frequency-time converting circuit for converting the dequantized main signal of a frequency domain into a time domain signal and an information multiplexing circuit for multiplexing the time domain signal and the blocking information.

Furthermore, the encoding device has an information separating circuit for separating the time domain signal and the blocking information from a multiplex signal, a time-frequency converting circuit for converting the time domain signal into a frequency domain signal on the basis of the blocking information obtained through the separation process; a psycho-acoustic model circuit for carrying out an acoustic sense analysis for the time domain signal, a control signal encoding circuit for generating a control signal for quantization and encoding on the basis of a psycho-acoustic model to carry out the encoding, a quantizing and encoding circuit for quantizing and encoding the frequency domain signal in accordance with the control signal, a stream multiplexing circuit for multiplexing the encoded control signal and the encoded frequency domain signal to generate an encoded stream and an output control circuit for controlling output timing of the encoded stream on the basis of the blocking information so that the processing delay time within the device becomes fixed.

As a result, there can be obtained the effects that it is possible to prevent the fluctuation of the total delay time, it is possible to suppress the difference in result of analyzing the psycho-acoustic model, and the variation of the generated control signals, and it is possible to suppress the quality degradation.

According to another aspect of the present invention, there is provided a decoding device for decoding an audio signal including a stream separating circuit for separating a main signal and a control signal from an encoded stream, a control signal decoding circuit for decoding the control signal obtained through the separation process to output blocking information, a decoding and dequantizing circuit for decoding and dequantizing the main signal obtained through the separation process in accordance with the decoded control signal, a frequency-time converting circuit for converting the dequantized main signal of a frequency domain into a time domain signal and an information multiplexing circuit for multiplexing the time domain signal and the blocking information.

As a result, there can be obtained the effects that the blocking information can be synchronously transmitted, and further, it is possible to fix the delay time when an audio signal passes through all the devices connected in a cascade style.

According to another aspect of the present invention, there is provided an encoding device for encoding an audio signal including an information separating circuit for separating a time domain signal and blocking information from a multiplex signal, a time-frequency converting circuit for converting the time domain signal into a frequency domain signal on the basis of the blocking information obtained through the separation process, a psycho-acoustic model circuit for carrying out an acoustic sense analysis for the time domain signal and a control signal encoding circuit for generating a control signal for quantization and encoding on the basis of the psycho-acoustic model to carry out the encoding.

Furthermore, the encoding device including a quantizing and encoding circuit for quantizing and encoding the frequency domain signal in accordance with the control signal, a stream multiplexing circuit for multiplexing the encoded control signal and the encoded frequency domain signal to generate an encoded stream and an output control circuit for controlling output timing of the encoded stream on the basis of the blocking information so that the processing delay time within the device becomes fixed.

As a result, there can be obtained the effects that the blocking information can be synchronously transmitted, and further, it is possible to fix the delay time when an audio signal passes through all the devices connected in a cascade style.

### BRIEF DESCRIPTION OF THE DRAWINGS

In the accompanying drawings:

FIG. 1 is a block diagram showing a configuration of a decoding device for decoding an audio signal according to a first embodiment of the present invention;

FIG. 2 is a block diagram showing a configuration of an encoding device for encoding an audio signal according to the first embodiment of the present invention;

FIGS. 3A and 3B are diagrams useful in explaining blocking information of the encoding device for encoding an audio signal according to the first embodiment of the present invention;

FIG. 4 is a diagram showing the situation of adjusting output time when a signal is outputted at a fixed transmission rate in the encoding device for encoding an audio signal according to the first embodiment of the present invention;

FIG. 5 is a diagram showing the situation when a timing difference d′ between frame timing of an encoding processing and timing of blocking information of a multiplex signal in the encoding device for encoding an audio signal according to the first embodiment of the present invention is different from a difference d therebetween shown in FIG. 4;

FIG. 6 is a block diagram showing a configuration of a decoding device for decoding an audio signal according to a second embodiment of the present invention;

FIG. 7 is a block diagram showing a configuration of an encoding device for encoding an audio signal according to the second embodiment of the present invention;

FIG. 8 is a diagram showing a format when psycho-acoustic model information is multiplexed to be outputted through an output terminal in an information multiplexing circuit of the encoding device for encoding an audio signal according to the second embodiment of the present invention;

FIG. 9 is a block diagram showing a configuration of a conventional audio signal decoding and encoding device; and

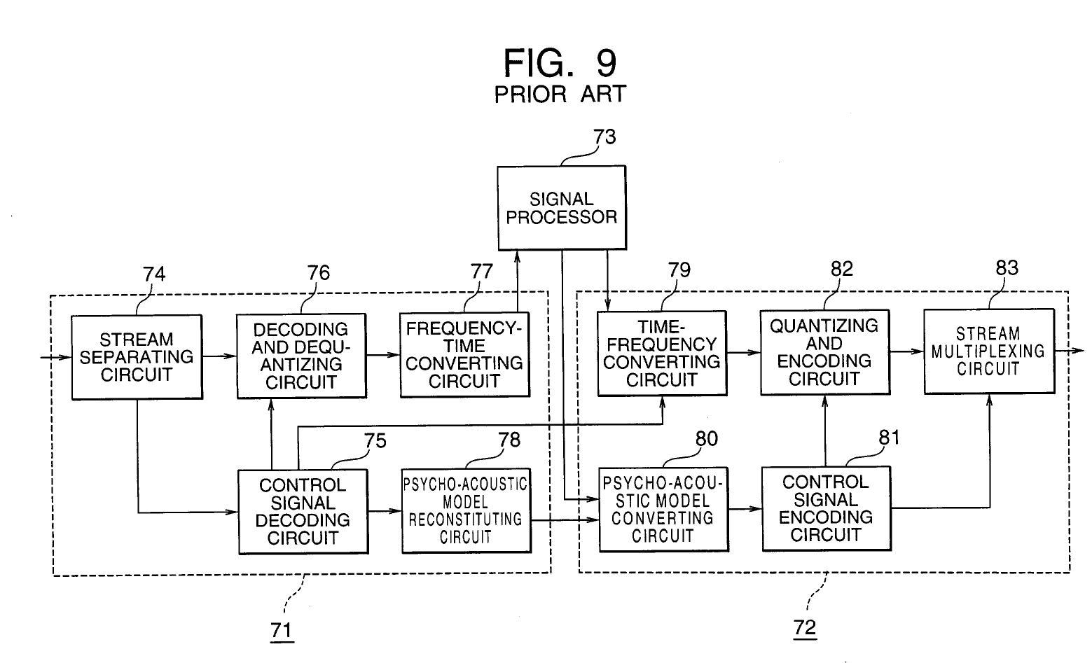

FIG. 10 is a diagram showing the operation of a conventional audio signal encoding device.

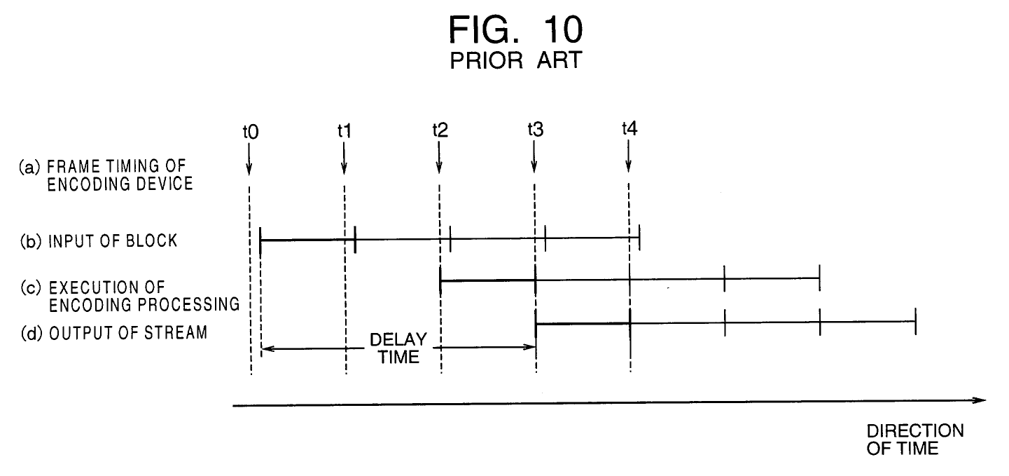

### DESCRIPTION OF THE PREFERRED EMBODIMENTS

The preferred embodiments of the present invention will hereinafter be described in detail with reference to the accompanying drawings.

First Embodiment

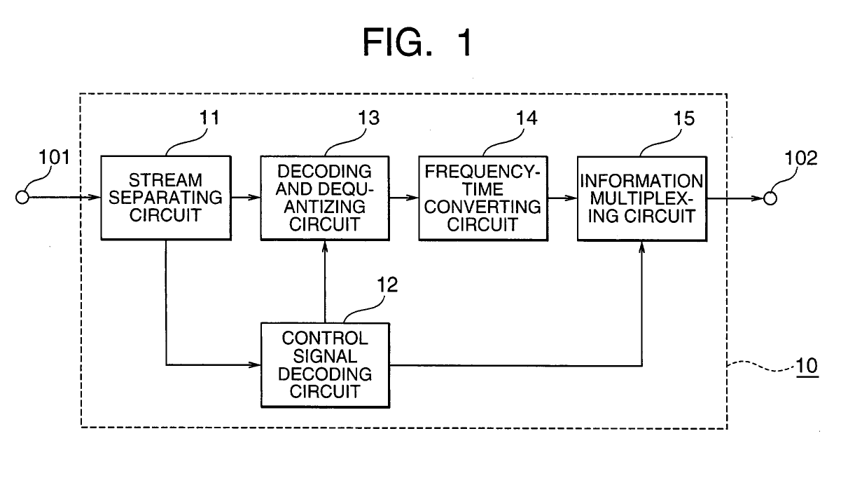

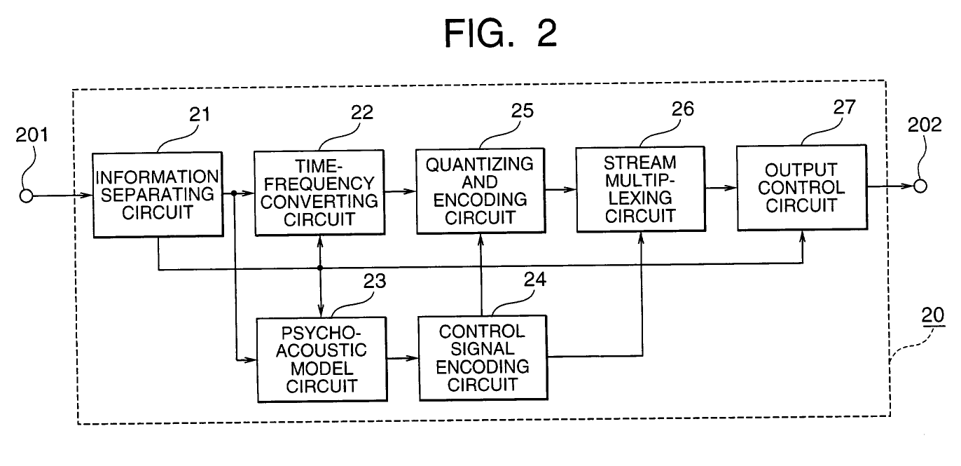

An audio signal decoding and encoding device according to a first embodiment of the present invention will hereinbelow be described with reference to FIGS. 1 and 2. FIG. 1 is a block diagram showing a configuration of a decoding device for decoding an audio signal according to the first embodiment of the present invention. In addition, FIG. 2 is a block diagram showing a configuration of an encoding device for encoding an audio signal according to the first embodiment of the present invention. By the way, in the figures, the same reference numerals designate the same or corresponding constituent elements.

In FIG. 1, reference numeral 10 denotes the whole decoding device; reference numeral 101 denotes an input terminal through which an encoded stream is inputted; reference numeral 11 denotes a stream separating circuit for separating a main signal and a control signal from the encoded stream; reference numeral 12 denotes a control signal decoding circuit for decoding the control signal obtained through the separation process to output blocking information; reference numeral 13 denotes a decoding and dequantizing circuit for decoding and dequantizing the main signal obtained through the separation process in accordance with the decoded control signal; reference numeral 14 denotes a frequency-time converting circuit for converting the dequantized main signal of a frequency domain into a time domain signal; reference numeral 15 denotes an information multiplexing circuit for multiplexing the time domain signal and the blocking information to output the resultant multiplex signal; and reference numeral 102 denotes an output terminal through which the multiplex signal is outputted.

In addition, in FIG. 2, reference numeral 20 denotes the whole encoding device; reference numeral 201 denotes an input terminal through which a multiplex signal is inputted; reference numeral 21 denotes an information separating circuit for separating a time domain signal and blocking information from the multiplex signal; reference numeral 22 denotes a time-frequency converting circuit for converting the time domain signal into a frequency domain signal on the basis of the blocking information obtained through the separation process; reference numeral 23 denotes a psycho-acoustic model circuit for carrying out the acoustic sense analysis for the time domain signal; reference numeral 24, a control signal encoding circuit for generating a control signal for quantization and encoding on the basis of the psycho-acoustic model to carry out the encoding; reference numeral 25, a quantizing and encoding circuit for quantizing and encoding the frequency domain signal in accordance with the control signal; reference numeral 26, a stream multiplexing circuit for multiplexing the encoded control signal and the encoded frequency domain signal to generate an encoded stream; reference numeral 27, an output control circuit for controlling output timing of the encoded stream on the basis of the blocking information; and 202, an output terminal through which the encoded stream is outputted.

The feature of the first embodiment of the present invention resides in the provision of the information multiplexing circuit 15, the information separating circuit 21 and the output control circuit 27.

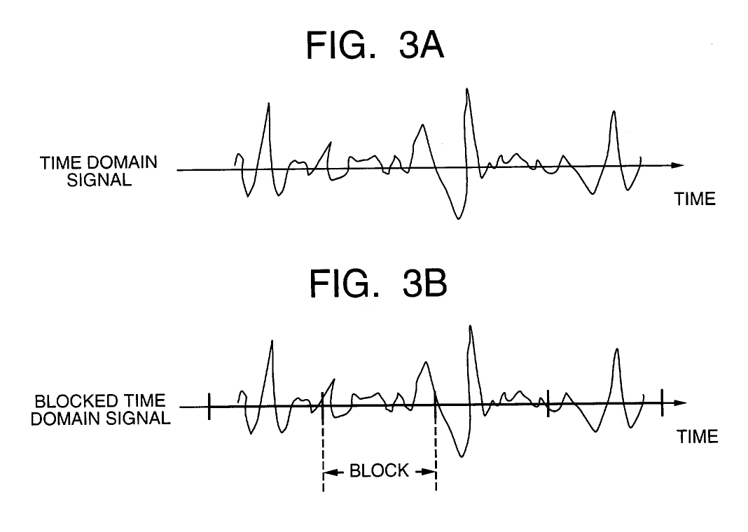

Next, the description will hereinbelow be given with respect to the operation of the audio signal decoding and encoding device according to the first embodiment with reference to FIGS. 3, 4 and 5.

FIGS. 3A and 3B are diagrams useful in explaining blocking information of the encoding device for encoding an audio signal according to the first embodiment of the present invention.

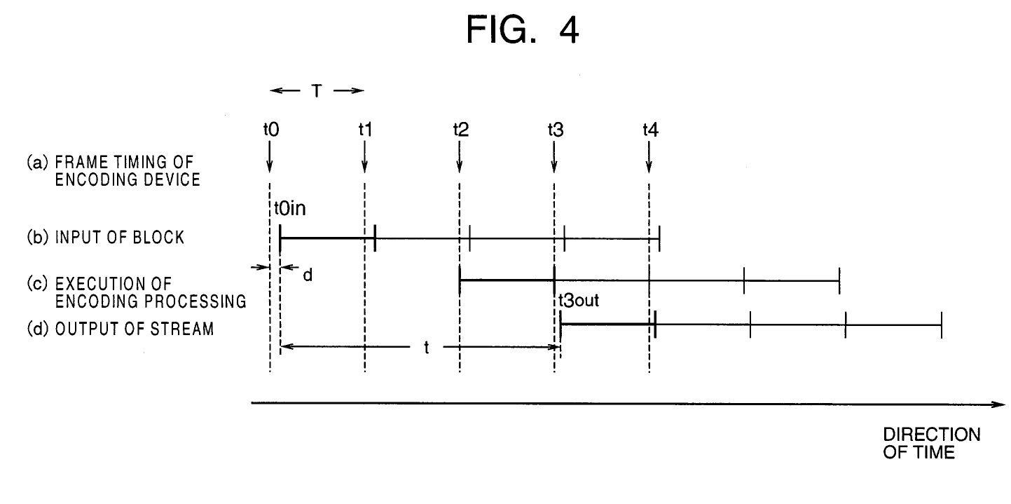

FIG. 4 is a diagram showing the situation of adjusting output time when a signal is outputted at a fixed transmission rate in the encoding device for encoding an audio signal according to the first embodiment of the present invention.

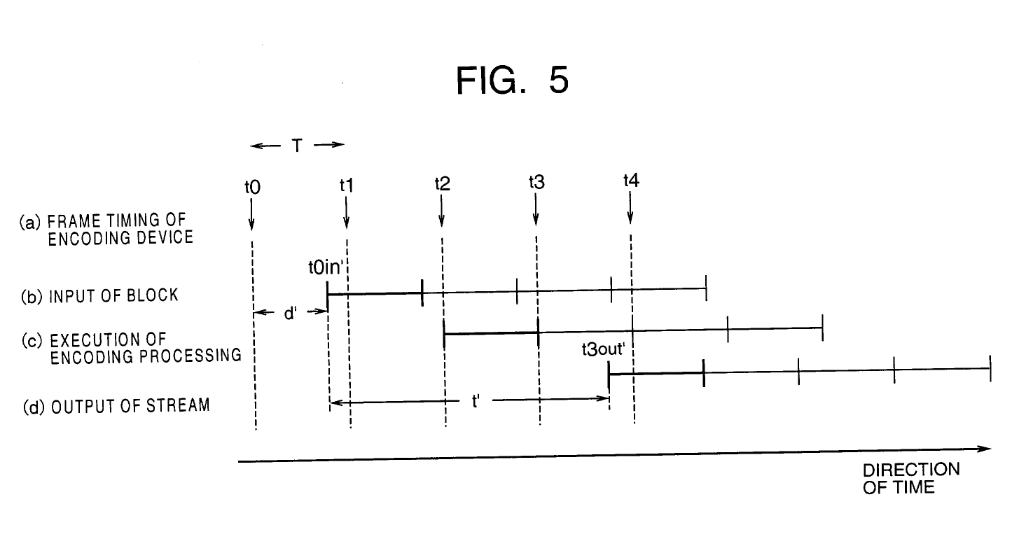

FIG. 5 is a diagram showing the situation when a timing difference d′ between frame timing of an encoding processing and timing of blocking information of a multiplex signal in the encoding device for encoding an audio signal according to the first embodiment of the present invention is different from a difference d therebetween shown in FIG. 4.

The encoded stream is inputted to the stream separating circuit 11 through the input terminal 101 of the decoding device 10 to be separated into the main signal as the signal of a frequency domain of the audio signal and other control signal.

The control signal obtained through the separation process is decoded in the control signal decoding circuit 12. The main signal outputted from the stream separating circuit 11 is decoded and dequantized in accordance with the decoded control signal by the decoding and dequantizing circuit 13.

The dequantized main signal is converted from the signal of a frequency domain into the signal of a time domain in the frequency-time converting circuit 14. In addition, the control signal decoding circuit 12 outputs the blocking information for the time domain signal. The information multiplexing circuit 15 multiplexes the blocking information and the time domain signal in the form of adding the blocking information to the time domain signal according to a predetermined output format to output the resultant multiplex signal through the output terminal 102.

In this case, the blocking information, as shown in FIG. 3A and 3B, means the time information of the partition boundaries when the time domain signal is divided into specific time partitions. In the blocking, sometimes there is the case where the time partition is always of a fixed length, and otherwise there is the case of the variable time partition which is adaptively variable. Normally, the processing partition of the encoding processing and the decoding processing is set on the basis of the blocking information.

The multiplex signal outputted from the decoding device 10 is inputted to the information separating circuit 21 through the input terminal 201 of the encoding device 20 to be separated into the blocking information and the time domain signal according to a predetermined format.

In the time-frequency converting circuit 22, the reblocking of the time domain signal is carried out on the basis of the blocking information to carry out the time-frequency conversion every block. Then, the blocking perfectly the same as that obtained from the blocking information may be carried out, or the blocking may be carried out with a fixed period of time being shifted by taking into account the delay difference due to the algorithm delay.

On the other hand, the psycho-acoustic model circuit 23 carries out the analysis for the time domain signal on the basis of the acoustic sense property of a human being, and the control signal encoding circuit 24 generates a control signal for the encoding from the psycho-acoustic model and encodes the control signal. The frequency domain signal generated in the time-frequency converting circuit 22 is quantized and encoded in accordance with the control signal generated in the control signal encoding circuit 24 in the quantizing and encoding circuit 25. Finally, the frequency domain signal and the control signal which have been encoded are multiplexed by the stream multiplexing circuit to become the multiple stream.

The output control circuit 27 controls the timing when the stream is outputted through the output terminal 202 on the basis of the blocking information from the information separating circuit 21. That is to say, the output control circuit 27 carries out the adjustment of the output time when the stream is outputted at a fixed transmission rate. FIG. 4 shows the situation of the adjustment concerned. The frame timing of the encoding processing in the encoding device 20 continues as t0, t1, . . . at fixed intervals T. In the case where the blocking information of the multiplex signal inputted to the encoding device 20 is t0in, t1in, . . . , the timing difference d thereof is d=t0in×t0. For the block with t0in as the origin, the encoding processing is started at a time point t2 after all the signals within the block concerned have been inputted. At a time point t3, the stream is already generated and hence this stream is outputted at and after the time point t3. At this time, the output control circuit 27 outputs the stream at timing of t3out after a lapse of d hours from the time point t3 by taking into account the timing difference d.

That is to say, a period of time t from input of the block of the multiplex signal to output thereof is expressed as follows.

$$\begin{matrix}t = t3out - t0in \\ = ( t3 + d ) - t0in \\ = \{ t3 + ( t0in - t0 ) - t0in \} \\ = t3 - t0 \\ = 3 T\end{matrix}$$

FIG. 5 shows the situation in the case where the timing difference d′ between the frame timing of the encoding processing in the encoding device 20 and the blocking information of the multiplex signal is different from the timing difference d therebetween in FIG. 4. Here, it is assumed that the relationship of T >d′>d≧0 is established. In this case as well, a period of time t′ from input of the block of the multiplex signal to output thereof is expressed as follows.

t′=3T

The control for the output timing as described above is carried out, whereby whatever timing relationship the blocking information of the multiplex signal has for the frame timing of the encoding processing in the encoding device 20, the delay time required for the audio signal to pass through the encoding device 20 becomes fixed. Thus, even if the decoding device 10 and the encoding device 20 are used under the condition in which they are cascade-connected in many stages, it becomes possible to prevent the fluctuation of the total delay time.

In addition, in the above-mentioned first embodiment, the blocking information is synchronously held in the decoding device 10 and the encoding device 20 which are cascade-connected. Thus, the same short time block is usually applied to the audio signal to execute the encoding processing so that the difference in result of analyzing the psycho-acoustic model, or the variation in the generated control signals is suppressed to allow the quality degradation to be suppressed.

Second Embodiment

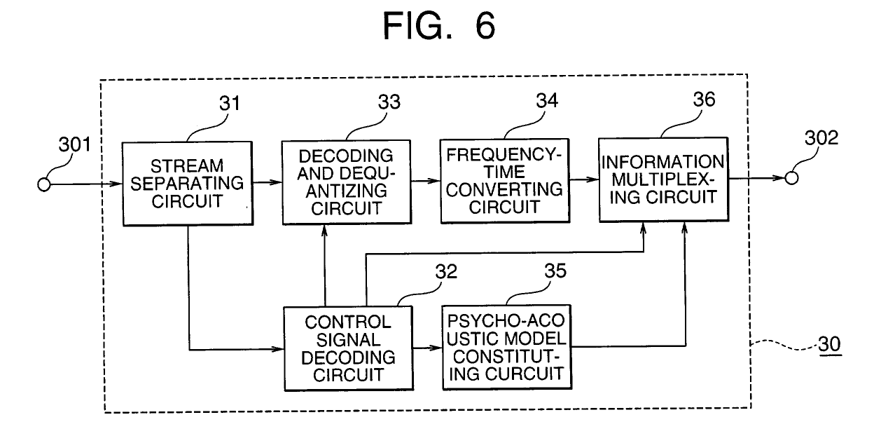

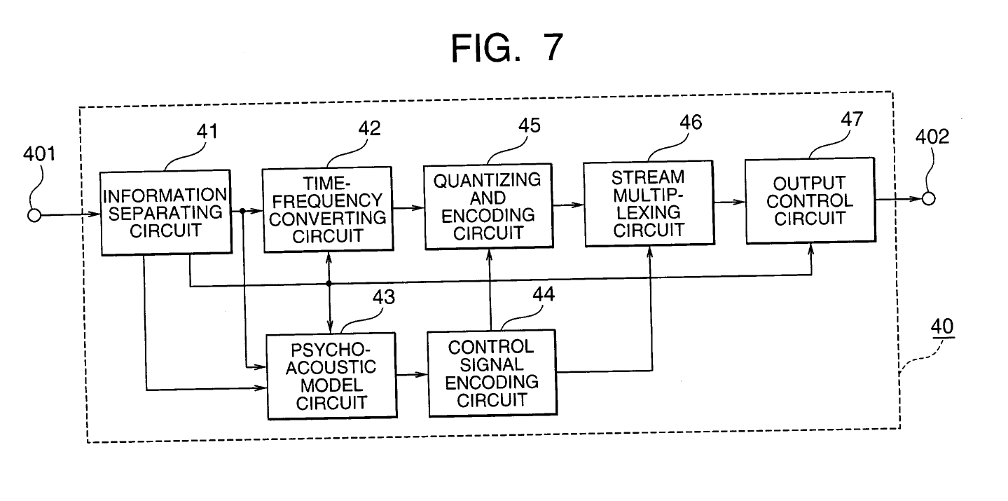

An audio signal encoding and decoding device according to a second embodiment of the present invention will hereinbelow be described with reference to FIGS. 6 and 7. FIG. 6 is a block diagram showing a configuration of a decoding device for decoding an audio signal according to the second embodiment of the present invention. In addition, FIG. 7 is a block diagram showing a configuration of an encoding device for encoding an audio signal according to the second embodiment of the present invention.

In FIG. 6, reference numeral 30 denotes the whole decoding device; reference numeral 301 denotes an input terminal through which an encoded stream is inputted; reference numeral 31 denotes a stream separating circuit for separating a main signal and a control signal from the encoded stream; reference numeral 32 denotes a control signal decoding circuit for decoding the control signal obtained through the separation process to output blocking information and encoding characteristic information; reference numeral 33 denotes a decoding and dequantizing circuit for decoding and dequantizing the main signal obtained through the separation process in accordance with the decoded control signal; reference numeral 34 denotes a frequency-time converting circuit for converting the dequantized main signal of a frequency domain into a time domain signal; reference numeral 35 denotes a psycho-acoustic model constituting circuit for constituting a psycho-acoustic model from the encoding characteristic information; reference numeral 36 denotes an information multiplexing circuit for multiplexing the time domain signal, the blocking information, and psycho-acoustic model information (parameters) to output the resultant multiplex signal; and reference numeral 302 denotes an output terminal through which the multiplex signal is outputted.

In addition, in FIG. 7, reference numeral 40 denotes the whole encoding device; reference numeral 401 denotes an input terminal through which a multiplex signal is inputted; reference numeral 41 denotes an information separating circuit for separating a time domain signal, blocking information, and psycho-acoustic model information from the multiplex signal; reference numeral 42 denotes a time-frequency converting circuit for converting the time domain signal into a frequency domain signal on the basis of the blocking information obtained through the separation process; reference numeral 43 denotes a psycho-acoustic model circuit for carrying out the acoustic sense analysis for the time domain signal; reference numeral 44, a control signal encoding circuit for generating a control signal for quantization and encoding on the basis of the psycho-acoustic model to carry out the encoding; reference numeral 45, a quantizing and encoding circuit for quantizing and encoding the frequency domain signal in accordance with the control signal; reference numeral 46, a stream multiplexing circuit for multiplexing the encoded control signal and the encoded frequency domain signal to generate an encoded stream; reference numeral 47, an output control circuit for controlling output timing of the encoded stream on the basis of the blocking information; and 402, an output terminal through which the encoded stream is outputted.

The feature of the second embodiment of the present invention resides in the provision of the psycho-acoustic model constituting circuit 35, the information multiplexing circuit 36, the information separating circuit 41 and the psycho-acoustic model 43.

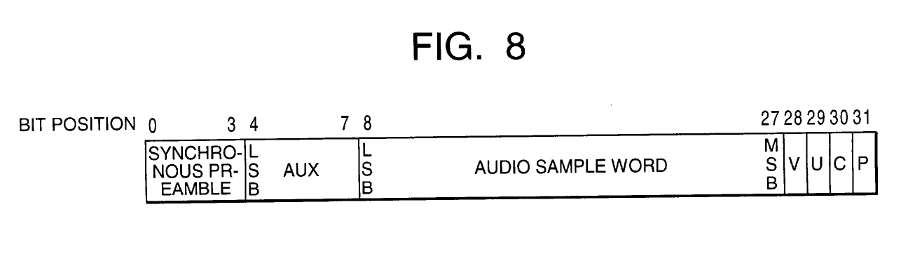

Next, the description will hereinbelow be given with respect to the operation of the audio signal decoding and encoding device according to the second embodiment with reference to FIGS. 7 and 8.

FIG. 8 is a diagram showing a format when psycho-acoustic model information is multiplexed to be outputted through an output terminal in an information multiplexing circuit of the encoding device for encoding an audio signal according to the second embodiment of the present invention.

The encoded stream is inputted to the stream separating circuit 31 through the input terminal 301 of the decoding device 30 to be separated into the main signal as the signal of a frequency domain of the audio signal and other control signal.

The control signal obtained through the separation process is decoded in the control signal decoding circuit 32. The main signal outputted from the stream separating circuit 31 is decoded and dequantized in accordance with the decoded control signal by the decoding and dequantizing circuit 33. The dequantized main signal is converted from the signal of a frequency domain into the signal of a time domain in the frequency-time converting circuit 34.

In addition, the control signal decoding circuit 32 outputs the blocking information for the signal of a time domain, and the encoding characteristic information. The psycho-acoustic model constituting circuit 35 constitutes the psycho-acoustic model on the basis of the encoded characteristic information. The information multiplexing circuit 36 multiplexes the time domain signal, and the blocking information and the psycho-acoustic model information in the form of adding the blocking information and the psycho-acoustic model information to the time domain signal in accordance with a predetermined format to output the resultant multiplex signal through the output terminal 302.

Here, the blocking information is as stated in the above-mentioned first embodiment. Also, the encoding characteristic information means the information exhibiting the characteristics of the encoding carried out in the encoding device connected in the stage prior to the decoding device. Thus, this information, for example, is the accuracy information of the quantization, or the amplitude level information of the encoded signal.

The accuracy of the quantization is determined from the analysis result based on the acoustic sense property in the encoding device connected in the prior stage. Then, the masking effect can be estimated from that information and the amplitude level information of the signal. The information of the psycho-acoustic model estimated on the basis of such information is the important parameter in the encoding system in which only the signals which a human being can feel with his/her acoustic sense are encoded to be transmitted. Thus, transmitting continuously such information to the encoding device in the next stage is important in terms of suppression of the quality degradation.

FIG. 8 shows a format when the psycho-acoustic model information (parameters) is multiplexed in the information multiplexing circuit 36 of the decoding device 30 to be outputted through the output terminal 302. This format is the format conforming to the digital audio interface format of the AES3 Standard.

The AES3 Standard has the time slot corresponding to 32 bits for one audio sample. That is to say, there is used 4 bits for the synchronous preamble, 4 bits for the auxiliary data (AUX), 20 bits for the time domain signal, i.e., the audio data, and 4 bits for the auxiliary code data (V, U, C, P) Here, an auxiliary data region is not normally used in many cases and the information (parameters) of the psycho-acoustic model is multiplexed in this region. By the way, the channel status information constituted by C of the auxiliary code data is managed so as to prevent this region from being used as the extended region of the audio data.

In addition, in FIG. 7, the multiplex signal outputted from the decoding device 30 is inputted to the information separating circuit 41 through the input terminal 401 of the encoding device 40 to be separated into the blocking information, the psycho-acoustic model information and the time domain signal in accordance with a predetermined format.

In the time-frequency converting circuit 42, the reblocking of the time domain signal is carried out on the basis of the blocking information to carry out the time-frequency conversion every block. Then, the blocking completely the same as that obtained from the blocking information may be carried out, or the blocking may be carried out with the fixed time being shifted by taking into account the delay difference due to the algorithm delay.

On the other hand, the psycho-acoustic model circuit 43, analyzes, while taking into consideration the psycho-acoustic model information obtained through the separation process in the information separating circuit 41, the time domain signal on the basis of the acoustic sense property of a human being. The control signal encoding circuit 44 generates a control signal for the encoding from the psycho-acoustic model to encode the control signal.

The frequency domain signal generated in the time-frequency converting circuit 42 is quantized and encoded in accordance with the control signal generated in the control signal encoding circuit 44 in the quantizing and encoding circuit 45.

Finally, the frequency domain signal and the control signal which have been encoded are multiplexed by the stream multiplexing circuit 46 to become the multiple stream. The output control circuit 47 adjusts the timing when the stream is outputted through the output terminal 402 on the basis of the blocking information from the information separating circuit 41 and also carries out the control so that the delay time concerned with the encoding device 40 becomes fixed. The details thereof are as stated in the above-mentioned first embodiment.

The output timing as described above is adjusted, and also the blocking information and the psycho-acoustic model information are synchronously transmitted to transmit continuously the special feature in the encoding in the prior stage to the next stage, whereby the difference in result of analyzing the psycho-acoustic model or the variation in the generated control signals can be suppressed, and hence it becomes possible to suppress the quality degradation.

While the present invention has been particularly shown and described with reference to the preferred embodiments, it will be understood that the various changes and modifications will occur to those skilled in the art without departing from the scope and true spirit of the invention. The scope of the invention is, therefore, to be determined solely by the appended claims.

What is claimed is:

1. An audio signal decoding and encoding device comprising:
a decoding device and an encoding device,
the decoding device having:
a stream separating circuit for separating a main signal and a control signal from an encoded stream;
a control signal decoding circuit for decoding the control signal obtained through the separation process to output blocking information;
a decoding and dequantizing circuit for decoding and dequantizing the main signal obtained through the separation process in accordance with the decoded control signal;
a frequency-time converting circuit for converting the dequantized main signal of a frequency domain into a time domain signal; and
an information multiplexing circuit for multiplexing the time domain signal and the blocking information, and
the encoding device having:
an information separating circuit for separating the time domain signal and the blocking information from a multiplex signal;
a time-frequency converting circuit for converting the time domain signal into a frequency domain signal on the basis of the blocking information obtained through the separation process;
a psycho-acoustic model circuit for carrying out an acoustic sense analysis for the time domain signal;
a control signal encoding circuit for generating a control signal for quantization and encoding on the basis of a psycho-acoustic model to carry out the encoding;
a quantizing and encoding circuit for quantizing and encoding the frequency domain signal in accordance with the control signal;
a stream multiplexing circuit for multiplexing the encoded control signal and the encoded frequency domain signal to generate an encoded stream; and
an output control circuit for controlling output timing of the encoded stream on the basis of the blocking information so that the processing delay time within the device becomes fixed.

2. An audio signal decoding and encoding device according to claim 1, wherein:
the decoding device further has a psycho-acoustic model constituting circuit for constituting a psycho-acoustic model from encoding characteristic information;
the control signal decoding circuit of the decoding device outputs the encoding characteristic information;
the information multiplexing circuit of the decoding device multiplexes psycho-acoustic model information as well from the psycho-acoustic model constituting circuit;
the information separating circuit of the encoding device separates the psycho-acoustic model information as well from the multiplex signal; and
the psycho-acoustic model circuit of the encoding device carries out the acoustic sense analysis for the time domain signal on the basis of the psycho-acoustic model information obtained through the separation process.

3. A decoding device for decoding an audio signal, comprising:
a stream separating circuit for separating a main signal and a control signal from an encoded stream;
a control signal decoding circuit for decoding the control signal obtained through the separation process to output blocking information;
a decoding and dequantizing circuit for decoding and dequantizing the main signal obtained through the separation process in accordance with the decoded control signal;
a frequency-time converting circuit for converting the dequantized main signal of a frequency domain into a time domain signal; and
an information multiplexing circuit for multiplexing the time domain signal and the blocking information.

4. A decoding device for decoding an audio signal according to claim 3, further comprising a psycho-acoustic model constituting circuit for constituting a psycho-acoustic model from encoding characteristic information, wherein:
the control signal decoding circuit outputs the encoding characteristic information; and
the information multiplexing circuit multiplexes psycho-acoustic model information as well from the psycho-acoustic model constituting circuit.

5. An encoding device for encoding an audio signal, comprising:
an information separating circuit for separating a time domain signal and blocking information from a multiplex signal;
a time-frequency converting circuit for converting the time domain signal into a frequency domain signal on the basis of the blocking information obtained through the separation process;
a psycho-acoustic model circuit for carrying out an acoustic sense analysis for the time domain signal;
a control signal encoding circuit for generating a control signal for quantization and encoding on the basis of the psycho-acoustic model to carry out the encoding;
a quantizing and encoding circuit for quantizing and encoding the frequency domain signal in accordance with the control signal;
a stream multiplexing circuit for multiplexing the encoded control signal and the encoded frequency domain signal to generate an encoded stream; and
an output control circuit for controlling output timing of the encoded stream on the basis of the blocking information so that the processing delay time within the device becomes fixed.

6. An encoding device for encoding an audio signal according to claim 5, wherein:
the information separating circuit separates the psycho-acoustic model information as well from the multiplex signal; and
the psycho-acoustic model circuit carries out the acoustic sense analysis for the time domain signal on the basis of the psycho-acoustic model information obtained through the separation process.
